(19) United States
(12) Patent Application Publication
(10) Pub. No.: US 2005/0267990 A1
(43) Pub. Date: Dec. 1, 2005

(54) Method for ascertaining an address for a communication terminal

(75) Inventors: Frank-Uwe Andersen, Berlin (DE); Hermann De Meer, Passau (DE); Ivan Dedinksi, Passau (DE); Tobias Hossfeld, Wurzburg (DE); Cornelia Kappler, Berlin (DE); Andreas Maeder, Wurzburg (DE); Jens Oliver Oberender, Passau (DE); Phuoc Tran-Gia, Wurzburg (DE); Kurt Tutschku, Gerbrunn (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/117,630

(22) Filed: Apr. 29, 2005

(30) Foreign Application Priority Data
Apr. 30, 2004 (DE) 10 2004 023 649.6

(51) Int. Cl. G06F 15/16

(52) U.S. Cl. 709/245

(57) ABSTRACT

The invention relates to a method for ascertaining an address for a peer communication terminal which holds a file. If peer communication terminals (P1, P2) repeatedly send request messages (N1, N2) to a first index server (IS1), with the request messages relating to a file (D) and with the first index server (IS1) not storing an address for a peer communication terminal which holds this file (D), then an interrogation device (AE) automatically ascertains an address (IP3) for a peer communication terminal (P3) which holds this file (D). This address (IP3) is transmitted to the first index server (IS1) by the interrogation device (AE). The first index server (IS1) then stores this address (IP3), so that when a further request message relating to this file appears the first index server (IS1) is able to provide this address (IP3) in response to the further request message.

### CLAIM FOR PRIORITY

This application claims the benefit of priority to German Application No. 10 2004 023 649.6, which was filed in the German language on Apr. 30, 2004, the contents of which are hereby incorporated by reference.

### TECHNICAL FIELD OF THE INVENTION

The invention relates to a method for ascertaining an address for a peer communication terminal which holds a file for the purpose of peer-to-peer data transmission.

### BACKGROUND OF THE INVENTION

Peer-to-peer data transmissions, in which peer communication terminals (often simply called “peers”) are connected to one another via a network, are general knowledge. The peer communication terminals can each perform the functions of either server or client during peer-to-peer data transmission. By way of example, a peer communication terminal can provide files (e.g. music files) for other peer communication terminals and can also retrieve them therefrom. The peer communication terminals can thus provide services for other peer communication terminals and can also retrieve services from other peer communication terminals. In this context, the peer communication terminals have equal authority among one another. The peer-to-peer data transmission between peer communication terminals differs from the data transmission between client and server computers in client/server communication networks. In the case of client/server data transmission, a communication terminal operates either as a server (which provides a service for another communication terminal) or as a client (which retrieves a service from a server). In the case of peer-to-peer data transmission, data are held locally in various peer communication terminals and are transmitted between them.

Particular variants of peer-to-peer telecommunication networks are called “hybrid P2P networks”. These hybrid P2P networks have one or more relatively highly centralized entities which perform particular tasks: central servers (known as “index servers”) store the information about which peer communication terminal holds the various data or files. When a peer communication terminal wishes to obtain a file, this peer communication terminal asks the index server for the address of a further peer communication terminal (or a plurality of further peer communication terminals) on which the desired file is held. The peer communication terminal then retrieves the file directly from the further peer communication terminal.

Peer-to-peer data transmissions today give rise to a considerable proportion of the data transmission volume which arises in telecommunication networks. It is estimated that between 50 and 80% of the data volume transmitted via the Internet comes from peer-to-peer data transmissions.

It is also general knowledge that a peer communication terminal responds to an input from its user by connecting to the index server and transmitting to the index server the information that a particular file is held by it (i.e. by this peer communication terminal) for other peer communication terminals for download. The information stored on the index server regarding which peer communication terminals hold which files is thus dependent on the transmission of information by the peer communication terminals.

The invention is based on the object of specifying a method which can be used to extend the stock of information stored in an index server.

The invention achieves this object by means of a method for ascertaining an address for a peer communication terminal which holds a file, having the following steps:
if peer communication terminals repeatedly send request messages to a first index server, with the request messages relating to a file and with the first index server not storing an address for a peer communication terminal which holds this file, then an interrogation device automatically ascertains an address for a peer communication terminal which holds this file,
the interrogation device transmits this address to the first index server, and
the first index server then stores this address, so that when a further request message relating to this file appears the first index server is able to provide this address in response to the further request message.

A particular advantage in this context is that for a file for which multiple request messages have already been sent to the first index server in the past (that is to say for a “popular” file for which multiple interest has already been shown) an address for a peer communication terminal which holds this file is automatically ascertained and stored in the first index server. As soon as a further request message relating to this file is received by the first index server, the first index server is then immediately able to provide the address for the peer communication terminal sending the request message.

The inventive method may proceed in a manner such that the interrogation device automatically ascertains the address of the peer communication terminal which holds this file by virtue of the interrogation device asking at least one further index server for this address. By interrogating the at least one further index server it is normally possible to ascertain the address of the peer communication terminal which holds the file very quickly.

The inventive method may have the following step: the interrogation device continues to ask further index servers for an address for a peer communication terminal which holds this file until one of the further index servers transmits this address to the interrogation device. This advantageously allows various index servers to be interrogated sequentially until the search for the address is successful and one of the further index servers transmits the address.

The inventive method may also proceed as follows: the interrogation device continues to ask further index servers for an address for a peer communication terminal which holds this file until one of the further index servers transmits an address for a peer communication terminal which is arranged in a stationary (fixed-location) part of a telecommunication network to the interrogation device. The address is then transmitted to the first index server by the interrogation device. In this case, it is particularly advantageous that the peer communication terminal arranged in the stationary part of the telecommunication network allows this file to be downloaded quickly and securely, since the file is already in the stationary part (landline part) of the telecommunication network during the download and does not need to be transmitted, for example via an air interface, from a mobile peer communication terminal to the stationary part of the telecommunication network first.

The inventive method may also proceed as follows: the interrogation device continues to ask further index servers for an address for a peer communication terminal which holds this file until one of the further index servers transmits an address for a peer communication terminal to the interrogation device, the peer communication terminal being in the same operator network as the first index server. In this refined form of the inventive method, the first index server is able, when a further request message relating to this file appears, to provide the address of a peer communication terminal which is in the same operator network as the first index server. This means that it is possible to avoid data transmission across operator networks when the file is subsequently downloaded by a peer communication terminal in the operator network, and this makes it possible to reduce the costs for the data transmission. This is because data transmission beyond the boundaries of its telecommunication network (operator network) is normally much more expensive for a network operator than data transmission within its own operator network, since usually it is necessary to pay usage fees for using “foreign” operator networks. The level of such usage fees is regulated in what are known as “peering agreements”, for example.

The inventive method may also proceed as follows: the interrogation device continues to ask further index servers for an address for a peer communication terminal which holds this file until the further index servers have transmitted a predetermined number of different addresses to the interrogation device. The predetermined number of different addresses is then transmitted to the first index server by the interrogation device. The first index server is therefore advantageously able, when a further request message relating to this file appears, to provide a plurality of addresses for file-providing peer communication terminals. This may be advantageous particularly when some (mobile or else fixed-location) peer communication terminals are temporarily unavailable (“offline”).

The inventive method may advantageously proceed such that when asking the further index servers for the address the interrogation device simulates an interrogating peer communication terminal. By simulating the interrogating peer communication terminal, the interrogation device can be integrated into existing peer-to-peer communication networks very easily and with little complexity. The reason for this is that from the point of view of the index servers and of the peer communication terminals the interrogation device is advantageously a peer communication terminal with which these are able to communicate using the usual communication protocols and rules. This means that the inventive method can also be implemented very quickly and with little cost involvement.

The inventive method may have the following steps:
the file-retrieval requests sent to the first index server by peer communication terminals are monitored by the first index server,
if peer communication terminals repeatedly send request messages to the first index server, with the request messages relating to a file and with the first index server not storing an address for a peer communication terminal which holds this file, then the first index server transmits an identifier to the file for the interrogation device, and
the interrogation device then automatically asks the at least one further index server for an address for a peer communication terminal which holds this file.

The requests sent to the first index server can be monitored particularly effectively by the first index server itself. Since the first index server responds to any request which it receives, monitoring can be performed particularly easily in the course of this response by producing and/or incrementing a counter for the requested file, for example.

The inventive method may also have the following steps:
the file-retrieval requests sent to the first index server by peer communication terminals are monitored by the interrogation device,
if peer communication terminals repeatedly send request messages to a first index server, with the request messages relating to a file and with the first index server not storing an address for a peer communication terminal which holds this file, then the interrogation device reads an identifier for the selected file from one of the request messages, and
the interrogation device then automatically asks the at least one further index server for an address for a peer communication terminal which holds this file.

In this refined form, the interrogation device is provided with access to the requests sent to the first index server. In this context, it is advantageous that the requests are monitored entirely in the interrogation device. This allows already existing index servers to be easily capacitated to participate in the inventive method by virtue of their being connected to the interrogation device and by virtue of the index servers forwarding the requests, for example, to the interrogation device.

To explain the invention further, the FIGURE shows an exemplary embodiment of a cycle through the inventive method.

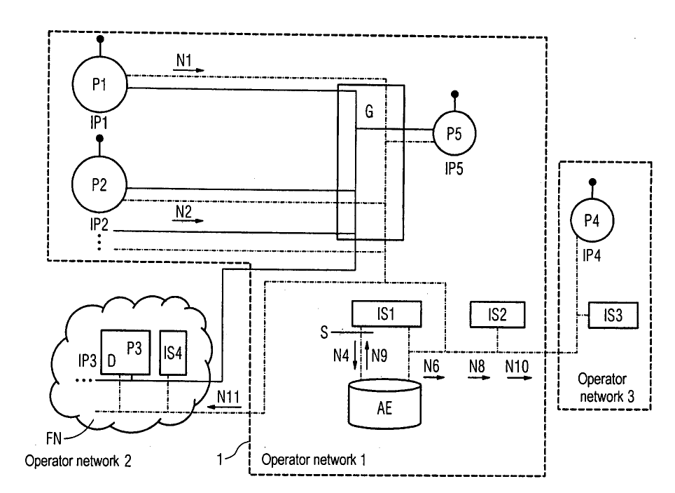

The left-hand side of FIGURE 1 shows a mobile peer communication terminal P1 (mobile peer) which is in the form of a mobile telephone and has an address in the form of an IP address IP1. In addition, a mobile peer communication terminal P2 is shown which has an associated IP address IP2. A stationary peer communication terminal P3 (fixed peer), which has an associated IP address IP3, forms a node in a peer-to-peer landline network FN (P2P landline network); the peer communication terminal P3 is a fixed-location peer communication terminal. Peer-to-peer landline networks are also called “fixed P2P networks”; examples of such peer-to-peer landline networks are the telephone landline network or the Internet with permanently installed workstation computers. The right-hand side of the FIGURE shows a further mobile peer communication terminal P4, which has an associated IP address IP4 and is in the form of a mobile telephone.

The mobile peer communication terminal P1 and the mobile peer communication terminal P2 belong to a first operator network 1 (“operator network 1”, first operator domain) belonging to a first network operator of a mobile radio network; they are thus under the control of the first network operator. The first network operator can transmit data within the first operator network 1 at the cost-of-sale price, i.e. he does not need to make any payments to other network operators for transmitting data. The area of the first operator network 1 is symbolized by a dashed line.

The peer-to-peer landline network FN is a second operator network (“operator network 2”, second operator domain) belonging to a second network operator; it is thus under the control of the second network operator. The second network operator can transmit data within the second operator network at the cost-of-sale price, i.e. he does not need to make any payments to other network operators for transmitting data.

The mobile peer communication terminals P1 and P2 are connected to a mobile radio network in the usual way; the base stations and switching centers used for this purpose are not shown in the FIGURE. An element which is shown in the mobile radio network is a gateway G (in the form of a Gateway GPRS Support Node, GGSN), to which the peer communication terminals P1 and P2 are connected. The gateway G can be used during peer-to-peer data transmission to transmit files (for example from the peer communication terminal P1 to the peer communication terminal P2). The file user-data transmission (P2P File Exchange) is symbolized in the FIGURE by means of solid lines. Dash-dot lines are used in the FIGURE to symbolize data transmission paths for signaling messages (common P2P/overlay signaling), with the signaling messages transmitted being such messages as prepare the actual user-data transmission. Such signaling messages are set up, by way of example, from the mobile peer communication terminal P1 to a first index server IS1 in order to ask this first index server IS1 for addresses for peer communication terminals which hold files which the peer communication terminal P1 wants. The first index server IS1 is connected via the signaling transmission channels (symbolized in the form of a dash-dot line) to an interrogation device AE which—as explained below—is used to ask or search for addresses for peer communication terminals and which in so doing simulates a peer communication terminal. For this reason, the interrogation device AE is a search peer communication terminal (search peer) and may also be called a “crawling peer” (crawler=search robot used in the Internet, for example). The first index server IS1 and the interrogation device AE additionally use an interface S (symbolized by means of a dash-dot line) to interchange special signaling messages. The interrogation device AE is likewise connected to a further index server IS2 via the signaling transmission channels (symbolized as a dash-dot line).

The gateway G, the first index server IS1, the interrogation device AE and the second index server IS2 are in the operator network 1 and are under the control of the network operator (in this case the control of the operator of the mobile radio network 1).

In addition, the interrogation device AE is connected to a third index server IS3 and to a further mobile peer communication terminal P4, which is shown in the right-hand part of the FIGURE. The third index server IS3 and the mobile peer communication terminal P4 belong to a third operator network 3 (“operator network 3”, third operator domain) belonging to a third network operator; they are thus under the control of the third network operator.

The peer-to-peer landline network FN contains a fourth index server IS4.

The text below gives a more detailed explanation of an exemplary embodiment of the method.

The mobile peer communication terminal P1 is intended to download a file D from a further peer communication terminal (downloading file D). However, the peer communication terminal P1 does not know which of the other peer communication terminals holds this file. For this reason, the peer communication terminal P1 sends a first request message N1 to the first index server IS1 via the gateway G. The first request message N1 relates to the file D, particularly to the availability of the file D (i.e. which peer communication terminal holds this file) or the retrieval of the file D (i.e. from which peer communication terminal this file can be retrieved).

However, the first index server IS1 does not store an address for a peer communication terminal which holds the file D. The first index server IS1 returns a corresponding response message (not shown) to the peer communication terminal P1 and, in a database, stores the information that the retrieval of file D in relation to a request message has been transmitted to it. (The request message N1 is sent to the first index server IS1, for example because the first index server IS1 is the only index server which is known to the peer communication terminal P1, because the peer communication terminal P1 is configured such that it always sends request messages to the first index server IS1 or because a proxy node (not shown in the FIGURE) in the operator network 1 reroutes the request message to the first index server IS1).

At a later time, for example a few hours later, the mobile peer communication terminal P2 sends a request message N2 relating to the retrieval of the file D to the first index server IS1. The first index server IS1 does not store an address for a peer communication terminal which holds this file. For this reason, the first index server IS1 returns a corresponding response message (not shown) to the mobile peer communication terminal P2 and uses its database to store the information that a second request message relating to the retrieval of the file D has been sent to it. On account of the fact that the second request message relating to the file D has already appeared, the first index server IS1 identifies that peer communication terminals have repeatedly sent it request messages which relate to the retrieval of the file D. However, the first index server does not store an address for a peer communication terminal which holds the file D. For this reason, the first index server IS1 uses the interface S to send an instruction message N4 to the interrogation device AE. This instruction message N4 prompts the interrogation device AE to ascertain an address for a peer communication terminal which holds the file D automatically. The instruction message N4 is used to transmit an identifier for the file D to the interrogation device. Examples of identifiers which may be transmitted for the file are: a search term (which can be used to ascertain the file), the full file name or a checksum value (e.g. what is known as a “hash value”, which clearly identifies the file).

In another exemplary embodiment, the inventive method may naturally also be in a form such that the instruction message N4 is not sent to the interrogation device AE until, by way of example, three or five request messages relating to the file D have been sent to the first index server IS1 or until a particular number of request messages per unit time has been exceeded (for example when more than ten request messages relating to the file D have been transmitted to the first index server IS1 in the last 24 hours).

The interrogation device AE now simulates an interrogating peer communication terminal and sends a request message N6 to the index server IS3. The interrogation device AE uses this request message N6 to ask the index server IS3 whether it has stored an address for a peer communication terminal which holds the file D. For this purpose, the interrogation device AE stores the addresses of a wide variety of index servers, in the exemplary embodiment the addresses of the index servers IS3 and IS2. The index server IS3 uses a response message (not shown) to respond that it does not store an address for a peer communication terminal which holds the file D. The interrogation device AE then sends a further request message N8 to the index server IS2. The index server IS2 stores the address of the peer communication terminal P3, since this peer communication terminal P3 holds the file D. The index server IS2 uses a response message (not shown) to return the address IP3 of the peer communication terminal P3 to the interrogation device AE. The interrogation device AE then uses a message N9 to transfer the address IP3 to the first index server IS1 via the interface S. The first index server IS1 stores the address IP3 in its data store. As soon as a further request message relating to the file D appears (for example such a further request message may be sent to the first index server IS1 by the peer communication terminal P1), the first index server IS1 provides the address IP3 in response to this further request message and transmits the address IP3 to the requesting peer communication terminal P1.

The peer communication terminal P3 is situated in a stationary part of a telecommunication network, namely in the peer-to-peer landline network FN. In one variant embodiment, the inventive method is in a form such that the interrogation device AE continues to ask further index servers for the address until one of the further index servers transmits an address for a peer communication terminal arranged in a stationary part of a telecommunication network to the interrogation device AE. Even if the index server IS3 had transmitted the address of the mobile telecommunication terminal P4 to the interrogation device AE in the method cycle described, the interrogation device would nevertheless have asked, as further index server, the index server IS2 whether it has a further address stored. The interrogation device AE is able to identify whether the peer communication terminal is arranged in a stationary part of a telecommunication network by evaluating the ping message response time of the respective peer communication terminal. To this end, the interrogation device AE sends a ping message to the respective peer communication terminal and ascertains the time which elapses before the ping response message (ICMP echo message) arrives (this time is also called the “ping roundtrip time” RTT). The peer communication terminals arranged in the stationary part of a telecommunication network have a much shorter ping message response time than mobile peer communication terminals, because the latter have to use the relatively slow air interface.

In another exemplary embodiment of the inventive method, the interrogation device AE continue to ask the further index servers (e.g. the index servers IS2, IS3 and other index servers, which are not shown in the FIGURE) for the address until one of the further index servers transmits an address for a peer communication terminal to the interrogation device, this peer communication terminal being in the same operator network as the first index server IS1. In the exemplary embodiment, this peer communication terminal is a mobile peer communication terminal P5 (mobile peer) which (like the first index server IS1) is arranged in the operator network 1. The peer communication terminal P5 has an associated IP address IP5.

A further exemplary embodiment of the inventive method is in a form such that the interrogation device continues to ask the further index servers for an address until the further index servers have transmitted a predetermined number of different addresses to the interrogation device. By way of example, the interrogation device AE may be in a form such that it does not stop interrogating the further index servers until three different addresses have been transmitted to the interrogation device AE by the further index servers. The interrogation device AE then transmits these three addresses to the first index server IS1. The first index server IS1 then stores these addresses (for example in the form of an address list in which the addresses are sorted according to the different ping message response times; that is to say according to the expected speed of a subsequent file download) and can provide them when a further request message relating to the file D appears.

In a further exemplary embodiment, the inventive method is in a form such that the interrogation device AE is provided with access to the request messages arriving on the first index server IS1 via the signaling data channel S symbolized by the dash-dot line. In this exemplary embodiment, the interrogation device AE monitors the requests (=request messages) sent to the first index server by peer communication terminals. As soon as the interrogation device AE establishes that request messages have been sent to the first index server IS1 repeatedly (the request messages relating to retrieval of the file D, for which the first index server IS1 does not store an address for a peer communication terminal which holds this file), the interrogation device AE reads an identifier for the corresponding file from a request message which is on the first index server IS1. By way of example, the interrogation device AE reads the file name of the file D from the last request message arriving on the first index server IS1 which relates to the file D. After that, the interrogation device AE automatically starts—as explained above—to ask the further index servers for an address for a peer communication terminal which holds this file.

A particular advantage of the method described is that the first index server IS1 is automatically supplied with addresses for peer communication terminals which hold popular (i.e. frequently requested) files. This makes it possible for network operators to provide their own index servers with address which are currently of interest. This has the effect that, when request messages (which relate to the popular files) arrive these index servers are able to provide addresses for peer communication terminals which provide these popular files. This advantageously prevents the requesting peer communication terminals from using index servers belonging to foreign network operators. The reason for this is that the use of foreign index servers, which are also situated in other operator networks, for example, normally results in high data transmission costs, since compensation payments need to be made between the various network operators. In addition, it advantageously ensures that the first index server IS1 stores the addresses of peer communication terminals which hold popular files, and that the first index server IS1 is therefore able to react immediately to corresponding request messages. This prevents a requesting peer communication terminal from sending multiple requests to different index servers, which reduces the volume of data which needs to be transmitted.

1. A method for ascertaining an address for a peer communication terminal which holds a file, having the following steps:
if peer communication terminals (P1, P2) repeatedly send request messages (N1, N2) to a first index server (IS1), with the request messages relating to a file (D) and with the first index server (IS1) not storing an address for a peer communication terminal which holds this file (D), then an interrogation device (AE) automatically ascertains an address (IP3) for a peer communication terminal (P3) which holds this file (D),
the interrogation device (AE) transmits this address (IP3) to the first index server (IS1), and
the first index server (IS1) then stores this address (IP3), so that when a further request message relating to this file appears the first index server (IS1) is able to provide this address (IP3) in response to the further request message.

2. The method as claimed in claim 1, characterized in that
the interrogation device (AE) automatically ascertains the address (IP3) of the peer communication terminal (P3) which holds this file (D) by virtue of the interrogation device (AE) asking at least one further index server (IS2, IS3) for this address.

3. The method as claimed in claim 1, characterized by the following step:
the interrogation device (AE) continues to ask further index servers (IS2, IS3) for an address for a peer communication terminal which holds this file until one of the further index servers (IS2) transmits this address to the interrogation device (AE).

4. The method as claimed in claim 1, characterized by the following step:
the interrogation device (AE) continues to ask further index servers (IS2, IS3) for an address for a peer communication terminal which holds this file until one of the further index servers (IS2) transmits an address (IP3) for a peer communication terminal (P3) which is arranged in a stationary part of a telecommunication network (FN) to the interrogation device.

5. The method as claimed in claim 1, characterized by the following step:
the interrogation device (AE) continues to ask further index servers (IS2, IS3) for an address for a peer communication terminal which holds this file until one of the further index servers transmits an address (IP5) for a peer communication terminal (P5) to the interrogation device (AE), the peer communication terminal being in the same operator network (1) as the first index server (IS1).

6. The method as claimed in claim 1, characterized by the following step:
the interrogation device (AE) continues to ask further index servers (IS2, IS3) for an address for a peer communication terminal which holds this file until the further index servers have transmitted a predetermined number of different addresses to the interrogation device.

7. The method as claimed in claim 1, characterized by the following step:
when asking the further index servers (IS2, IS3) for the address the interrogation device (AE) simulates an interrogating peer communication terminal.

8. The method as claimed in claim 1, characterized by the following steps:
the file requests sent to the first index server (IS1) by peer communication terminals are monitored by the index server (IS1),
if peer communication terminals (P1, P2) repeatedly send request messages (N1, N2) to the first index server (IS1), with the request messages relating to a file (D) and with the first index server (IS1) not storing an address for a peer communication terminal which holds this file (D), then the first index server (IS1) transmits (N4) an identifier for the file to the interrogation device (AE), and
the interrogation device (AE) then automatically asks the at least one further index server (IS2, IS3) for an address (IP3) for a peer communication terminal (P3) which holds this file.

9. The method as claimed in claim 1, characterized by the following steps:
the file-retrieval requests sent to the first index server (IS1) by peer communication terminals are monitored by the interrogation device (AE),
if peer communication terminals (P1, P2) repeatedly send request messages (N1, N2) to a first index server (IS1), with the request messages relating to a file (D) and with the first index server (IS1) not storing an address for a peer communication terminal which holds this file (D), then the interrogation device (AE) reads an identifier for the selected file (D) from one of the request messages, and
the interrogation device then automatically asks the at least one further index server (IS2, IS3) for an address for a peer communication terminal which holds this file.
